(19) United States
(12) Patent Application Publication
(10) Pub. No.: US 2026/0150830 A1
(43) Pub. Date: Jun. 4, 2026

(54) SYSTEM AND METHOD FOR CAPTURING INSECTS

(71) Applicants: The United States of America, as Represented by the Secretary of Agriculture, Washington, DC (US); THE REGENTS OF THE UNIVERSITY OF CALIFORNIA, Oakland, CA (US)

(72) Inventors: DANIEL K. HASEGAWA, SALINAS, CA (US); IAN GRETTENBERGER, WOODLAND, CA (US)

(21) Appl. No.: 18/964,939

(22) Filed: Dec. 2, 2024

(51) Int. Cl. A01M 1/08

(52) U.S. Cl. CPC A01M 1/08; A01M 2200/012

(57) ABSTRACT

Systems and methods for capturing insects are disclosed. This disclosure relates to a device for capturing insects, the device comprising a fan; a housing, wherein the fan is disposed in the housing; an insect collection chamber, the insect collection chamber coupled to the housing; and wherein the insect collection chamber comprises a capture liquid disposed in the insect collection chamber. In some embodiments, the device may include a collection vane. In certain embodiments, the device may include a vent chamber, where the vent chamber comprises at least one air vent. In some embodiments, the air vent comprises a mesh, where the air vent allows a volume of air to pass through the mesh without allowing a targeted insect to pass through the mesh.

### FIELD

The disclosed subject matter relates generally to systems and methods for capturing insects. Specifically, the subject matter described herein relates to systems and methods for monitoring and capturing thrips.

### BACKGROUND

Thrips (order Thysanoptera) are minute (mostly 1 mm (0.039 in) long or less) and slender insects having fringed wings and asymmetrical mouthparts. Current technologies to monitor thrips rely on the use of sticky cards, which are 5″×7″ pieces of colored cardboard (e.g., blue or yellow) that is lined with an adhesive to capture insects. The technology is messy, time consuming, and is not conducive for removing specimens for performing additional diagnostics. Thus, the current technology limits the ability to accurately identify the species of thrips that are present and determine if they are actively vectoring plant pathogenic viruses. Additionally, the current technology captures non-target insects (also referred to as, “bycatch”), including pollinators, parasitoids, and predatory insects, which provide important beneficial services for the environment. Current technologies are time consuming, and prone to capturing other insects, including those that are beneficial to the environment (pollinators and parasitoids).

While the existing systems and methods are useful to a degree, they still suffer from certain limitations. Therefore, there exists a need in the art for improved systems and methods for monitoring and capturing insects that solve or at least alleviate some or all of these problems.

### SUMMARY OF THE EMBODIMENTS

Systems and methods for capturing insects are disclosed and claimed herein.

As described more fully below, the devices and processes of the embodiments disclosed permit improved systems and methods for capturing insects. Further aspects, objects, desirable features, and advantages of the apparatus, systems, and methods disclosed herein will be better understood and apparent to one skilled in the relevant art in view of the detailed description and drawings that follow, in which various embodiments are illustrated by way of example. It is to be expressly understood, however, that the drawings are for the purpose of illustration only and are not intended as a definition of the limits of the claimed embodiments.

To this end, an insect capturing device is provided, the device comprising: a fan; a housing, wherein the fan is disposed in the housing, the housing having an intake opening and an exhaust opening; an insect collection chamber, the insect collection chamber coupled to the housing; and wherein the insect collection chamber comprises a capture liquid disposed in the insect collection chamber.

In some embodiments, the device further comprises a collection vane. In certain embodiments, the collection vane is coupled to a top of the housing. In various embodiments, the device further comprises a vent chamber is in gaseous communication with the housing. In some embodiments, the device further comprises an insect collection chamber in gaseous communication with the housing. In some embodiments, the device further comprises a funnel disposed between the fan and the insect collection chamber.

In certain embodiments, the housing is coupled to a top end of the funnel. In various embodiments, the insect collection chamber is coupled to a bottom end of the vent chamber. In some embodiments, the vent chamber comprises at least one air vent. In certain embodiments, the air vent comprises a mesh. In various embodiments, the air vent allows a volume of air to pass through the mesh without allowing a targeted insect to pass through the mesh. In some embodiments, the air vent is disposed in a side wall of the vent chamber.

In various embodiments, the collection vane is disposed above the housing. In some embodiments, the collection vane is blue. In certain embodiments, the capture liquid comprises water. In various embodiments, the capture liquid comprises a mixture of water and soap. In certain embodiments, the capture liquid comprises a mixture of water, soap, and propylene glycol. In some embodiments, the device further comprises a solar panel electrically connected to the fan.

In one form, an insect capturing device is provided, the device comprising: a fan; a housing, wherein the fan is disposed in a housing, the housing having an intake opening and an exhaust opening; an insect collection chamber, the insect collection chamber coupled to the housing; and a collection vane coupled to a top of the housing.

In some embodiments, the insect collection chamber comprises a capture liquid disposed in the insect collection chamber. In certain embodiments, the device further comprises a vent chamber is in gaseous communication with the housing. In various embodiments, the device further comprises a funnel disposed between the fan and the insect collection chamber. In some embodiments, the vent chamber comprises at least one air vent, the air vent comprising a mesh, wherein the air vent allows a volume of air to pass through the mesh without allowing a targeted insect to pass through the mesh. In certain embodiments, the collection vane is a color in the electromagnetic wavelength range of 420-470 nanometers.

In one form, an insect capturing device is provided, the device comprising: a fan; a housing, wherein the fan is disposed in a housing, the housing having an intake opening and an exhaust opening; an insect collection chamber, the insect collection chamber coupled to the housing; and a vent chamber is in gaseous communication with the housing.

In certain embodiments, the device further comprises a collection vane coupled to a top of the housing; and a funnel disposed between the fan and the insect collection chamber. In various embodiments, the vent chamber comprises at least one air vent, the air vent comprising a mesh, wherein the air vent allows a volume of air to pass through the mesh without allowing a targeted insect to pass through the mesh; wherein the insect collection chamber comprises a capture liquid disposed in the insect collection chamber; and wherein the collection vane is blue.

In one form, a method for capturing insects is provided, the method comprising the steps of: directing a target insect into a funnel by the direction of the airflow of a fan; directing the target insect into an insect collection chamber by the direction of the airflow of the fan; and collecting the target insect in a collection liquid in the insect collection chamber.

In some embodiments, the method further comprises the step of: attracting the target insect. In various embodiments, the method further comprises the step of: attracting the target insect and excluding bycatch. In certain embodiments, the method further comprises the step of: expelling the fan exhaust through an air vent. In various embodiments, the method further comprises the step of: removing the collected insect for further study or tests. In some embodiments, the method further comprises the step of: determining a species of the target insect. In certain embodiments, the method further comprises the step of: determining if the target insect contains, carries, or is infected with a pathogen.

These and other objects, features, aspects, and advantages of the present patent document will become better understood with reference to the following description and accompanying drawings.

### BRIEF DESCRIPTION OF THE DRAWINGS

FIG. 1 illustrates a bottom perspective view of an embodiment of a system for capturing insects of the present patent document.

FIG. 2 illustrates a side view of an embodiment of a system for capturing insects of the present patent document shown in FIG. 1.

FIG. 3 illustrates a cross-sectional view of an embodiment of a system for capturing insects of the present patent document along the line A-A shown in FIG. 2.

FIG. 4 illustrates a cross-sectional view of an embodiment of a system for capturing insects of the present patent document along the line A-A shown in FIG. 2, now showing a collection chamber.

FIG. 5 illustrates a zoomed-in side view of a vent chamber of a system for capturing insects of the present patent document in segment B shown in FIG. 2.

FIG. 6 illustrates a zoomed-in side view of a vent chamber of a system for capturing insects of the present patent document in segment B shown in FIG. 2, now showing a collection chamber.

FIG. 7 illustrates a top perspective view of an embodiment of a system for capturing insects of the present patent document.

FIG. 8 illustrates a top view of an embodiment of a system for capturing insects of the present patent document.

FIG. 9 illustrates a graph of the average number of bycatch caught in different traps in an experiment.

FIG. 10 illustrates a graph of the average number of thrips caught in different traps in an experiment.

FIG. 11 illustrates a process for capturing insects of the present patent document.

Note that assemblies/systems in some of the figures may contain multiple examples of essentially the same component. For simplicity and clarity, only a small number of the example components may be identified with a reference number. Unless otherwise specified, other non-referenced components with essentially the same structure as the exemplary component should be considered to be identified by the same reference number as the exemplary component. Further, unless specifically indicated otherwise, drawing components may or may not be shown to scale.

### DETAILED DESCRIPTION OF PREFERRED EMBODIMENTS

Reference will now be made to the drawings in which the various elements of the present disclosure will be given numerical designations and in which the present disclosure will be discussed so as to enable one skilled in the art to make and use the present disclosure. It is to be understood that the following description is only exemplary of the principles of the present disclosure, and should not be viewed as narrowing the claims. Additionally, it should be appreciated that the components of the individual embodiments discussed may be selectively combined in accordance with the teachings of the present disclosure. Furthermore, it should be appreciated that various embodiments will accomplish different objects of the present disclosure, and that some embodiments falling within the scope of the present disclosure may not accomplish all of the advantages or objects which other embodiments may achieve.

In accordance with the present disclosure, improved systems and methods for capturing insects are disclosed which address, or at least ameliorate one or more of the problems of existing designs.

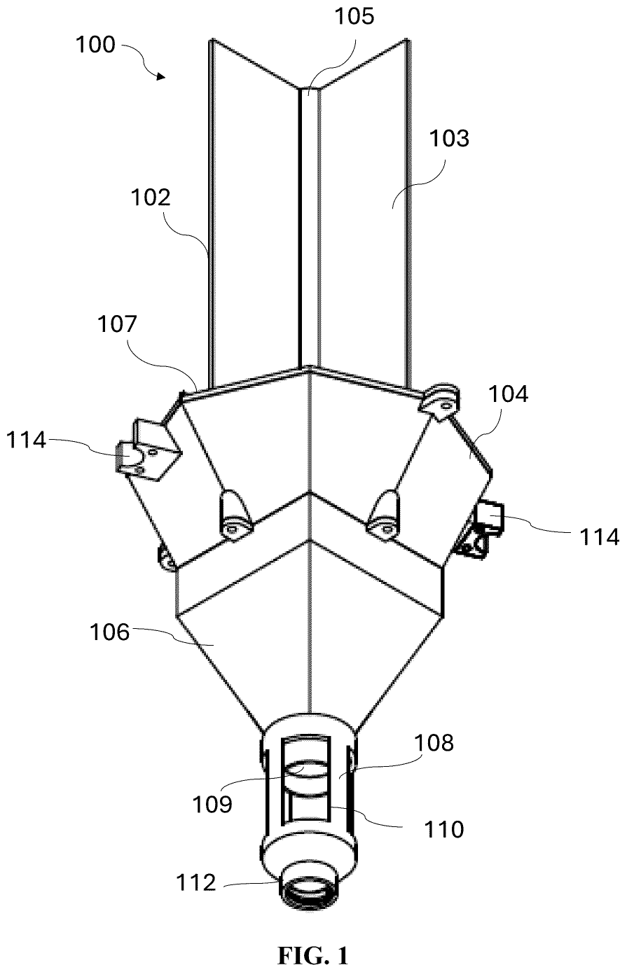

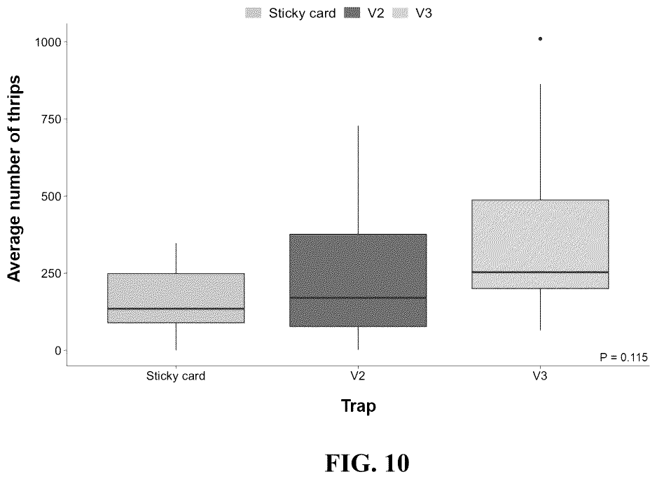

FIG. 1 illustrates a bottom perspective view of an embodiment of a system for capturing insects of the present patent document. Referring to FIG. 1, there is shown a bottom perspective view of an embodiment of an insect capturing device 100 of the present patent document. In a preferred embodiment, the insect capturing device 100 may have a fan 140 (see FIG. 10) and a housing 104, where the fan 140 may be disposed in the housing 104. The housing 104 may have an intake opening 107 and an exhaust opening 109. In some embodiments, the intake opening 107 may be referred to as a top opening. and an exhaust opening 109 may be referred to as a bottom opening. In certain embodiments, the housing 104 may have a funnel 106. In various embodiments, the funnel 106 may be a part of the housing 104 and made from the same piece as the housing 104. In other embodiments, the funnel 106 may be a separate piece from the housing 104. In some embodiments, the funnel 106 may be coupled to the housing 104. The funnel 106 may have a top opening and a bottom opening. In some embodiments, an insect capturing device 100 may be referred to as an insect capturing system.

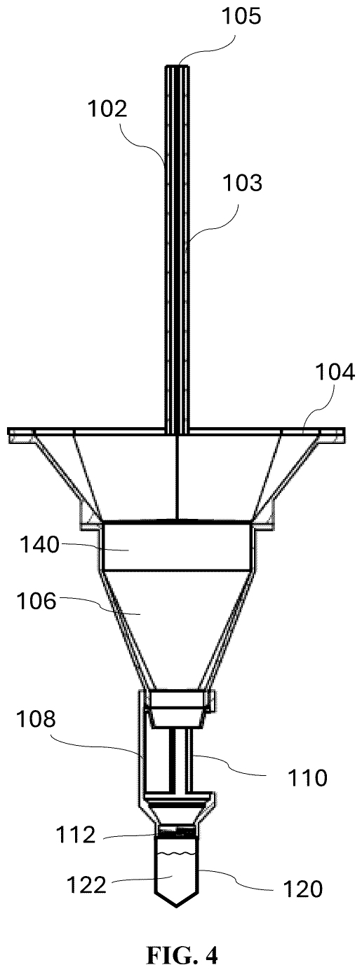

The insect capturing device 100 may have a vent chamber 108. In some embodiments, the vent chamber 108 may be coupled to the housing 104. In certain embodiments, the vent chamber 108 may be coupled to the funnel 106. The insect capturing device 100 may have a collection chamber 120 (see FIG. 4) for collecting insects. In some embodiments the collection chamber 120 may be coupled to the vent chamber 108. In certain embodiments, the collection chamber 120 may be coupled to the funnel 106 or the housing 104. The collection chamber 120 may have a capture liquid 122 disposed in the collection chamber 120. In some embodiments, the capture liquid 122 may be water. In certain embodiments, the capture liquid 122 may have water and soap. In a preferred embodiment, the capture liquid 122 may be a mixture of water, soap, and propylene glycol. Propylene glycol is a common solution used for preserving insects. In some embodiments, the collection chamber 120 may also be referred to as a collection vial. The collection chamber 120 may also be referred to as an insect collection chamber.

The insect capturing device 100 may have a collection vane 102. The collection vane may be coupled to a top end of the housing 104. The collection vane 102 may be disposed above the housing 104. In some embodiments, the collection vane 102 may have a spine 105 with flaps or panels 103 connected to the spine 105. In the embodiment shown in FIG. 1, there are four panels 103 connected to the spine 105 at right angles. The collection vane 102 may be any suitable color. In certain embodiments, the collection vane 102 may be a particular color to attract a target insect. In a preferred embodiment where the target insect is thrips, the collection vane 102 may be blue. In other embodiments other colors may be used. In some embodiments, the collection vane may be yellow. The collection vane 102 may also be referred to as a wind vane.

The funnel 106 may be disposed between the fan 140 and the collection chamber 120. The housing 104 may be coupled to a top end of the funnel 106. The collection chamber 120 may be coupled to a bottom end 112 of the vent chamber 108. The vent chamber 108 may be in gaseous communication with the housing 104. The collection chamber 120 may be in gaseous communication with the housing 104 and the vent chamber 108.

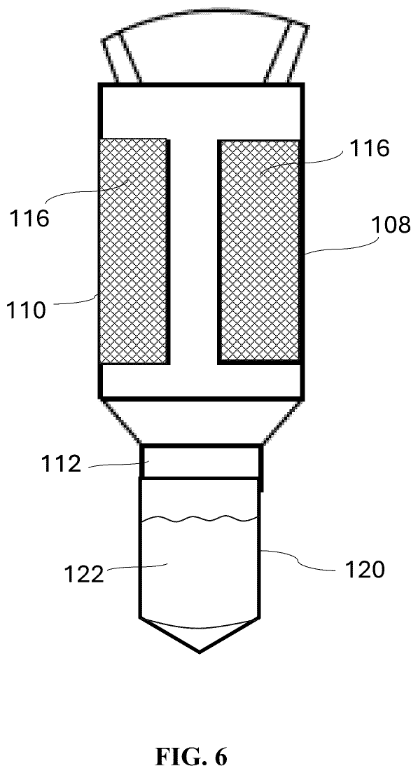

The vent chamber 108 may have at least one air vent 110. Air vents 110 may be disposed in a side wall of the vent chamber 108. An air vent 110 may have a mesh 116 (see FIG. 6) spanning the air vent 110. In other embodiments, a fabric or a cloth may span the air vent 110. The vent chamber 108 may also be referred to as a ventilated chamber or a ventilation chamber.

The insects may be attracted to the color of the collection vane 102. As the insects approach the collection vane 102 they may be sucked in or directed by the airflow of the fan 140 into the housing 104, where the insects may flow through the fan 140 into the funnel 106. The insects may then pass through the vent chamber 108 into the collection chamber 120, and into the collection liquid 122, where they may become trapped. Since the insects are in a liquid, they may be collected and removed for further study, such as tests to determine if the insects carry a pathogen.

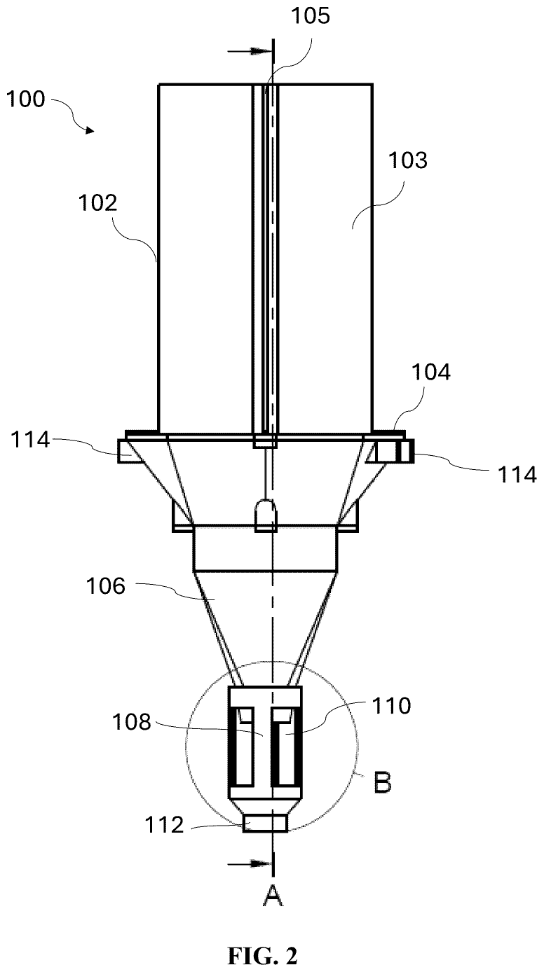

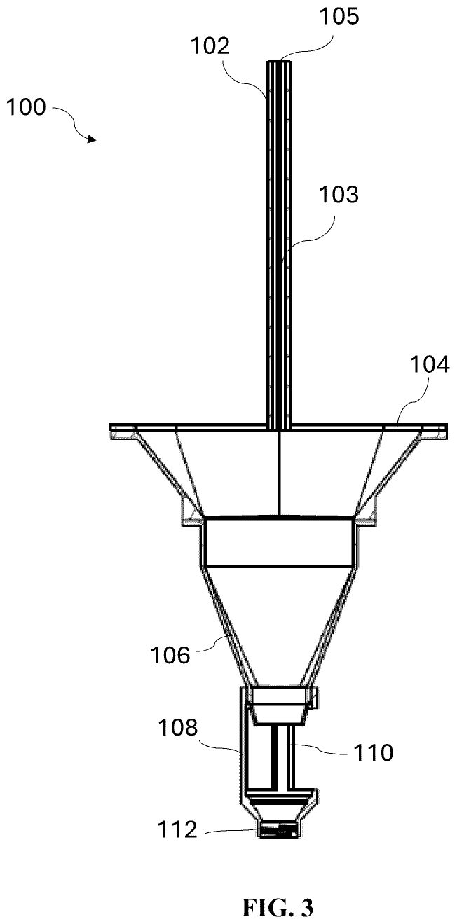

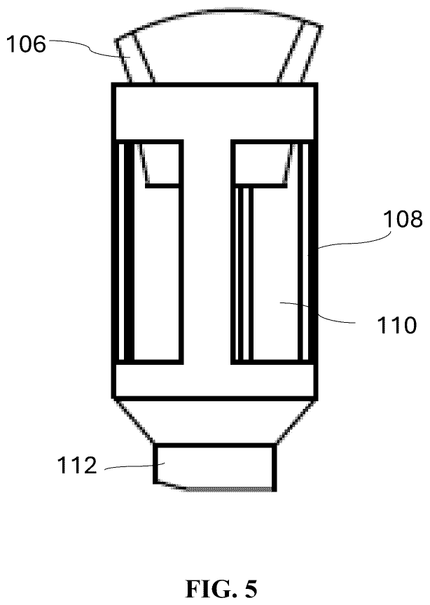

FIG. 2 illustrates a side view of an embodiment of a system for capturing insects of the present patent document shown in FIG. 1. In FIG. 2, a line A-A is shown for the cross-sectional view of FIG. 3, and a segment B is shown for a zoomed-in side view of FIG. 5.

FIG. 3 illustrates a cross-sectional view of an embodiment of a system for capturing insects of the present patent document along the line A-A shown in FIG. 2. In FIG. 3, the collection vane 102 is shown operatively connected to the housing 104, the housing 104 is operatively connected to the funnel 106, and the funnel 106 is operatively connected to the vent chamber 108.

FIG. 4 illustrates a cross-sectional view of an embodiment of a system for capturing insects of the present patent document along the line A-A shown in FIG. 2, now showing collection chamber. In FIG. 4 there is shown a cross-sectional view of the collection chamber 120 operatively connected to the vent chamber 108, with a collection liquid 122 located in the collection chamber 120.

FIG. 5 illustrates a zoomed-in side view of a vent chamber of a system for capturing insects of the present patent document in segment B shown in FIG. 2. In FIG. 5, a mesh is shown spanning the air vents 110.

FIG. 6 illustrates a zoomed-in side view of a vent chamber of a system for capturing insects of the present patent document in segment B shown in FIG. 2, now showing collection chamber. In FIG. 6, a close up view is shown of the collection chamber 120 operatively connected to the vent chamber 108, with a collection liquid 122 located in the collection chamber 120. The insect capturing device 100 is conducive for removing specimens for performing additional diagnostics since the insects can be easily extracted from the collection liquid 122.

In FIG. 6 an air vent 110 is shown with a mesh 116 spanning the air vent 110. The mesh 116 may span the opening of the air vent 110 such that air is capable of passing through the air vent 110, but insects are prevented from passing through the air vent 110. In some embodiments the mesh 116 may be made of plastic. In other embodiments the mesh 116 may be made of metal or metal wires. In other embodiments, a fabric or a cloth may span the air vent 110. The air vent 110 may allow a volume of air to pass through the mesh 116 without allowing a targeted insect to pass through the mesh 116.

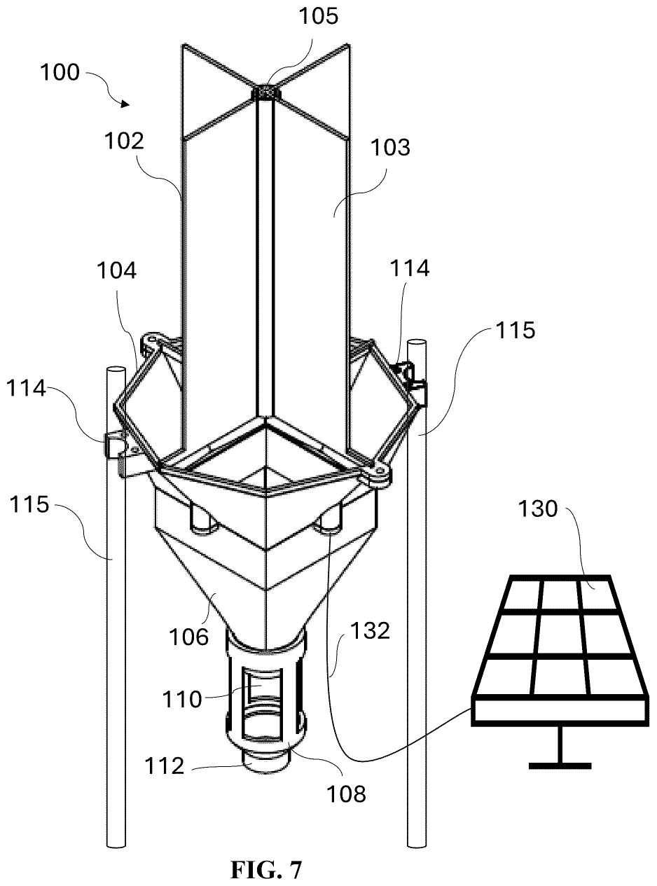

FIG. 7 illustrates a top perspective view of an embodiment of a system for capturing insects of the present patent document. The insect capturing device 100 may have a solar panel 130 electrically connected to the fan 140 by wires 132. In other embodiments, other suitable power sources may be used, including, but not limited to, a battery, an electrical outlet, or a generator. The housing 104 may have a support stand or supports 115 coupled to the housing 104 to support and secure the insect capturing device 100. The support stand may elevate the insect capturing device 100 off of the ground. A support stand may be made of supports 115.

In FIG. 7, the collection vane 102 is shown coupled to a top of the housing 104. In the embodiment shown in FIG. 7, supports 115 are shown operatively connected to support holders 114 on opposite sides of the housing 104, so support the weight of the housing 104 and attached components of the insect capturing device 100. The supports 115 may also be referred to as a support stand or support legs. The support holders 114 may also be referred to as support brackets. The supports 115 may be hammered or otherwise inserted into the dirt or ground (not shown) to prevent the insect capturing device 100 from falling or tipping over.

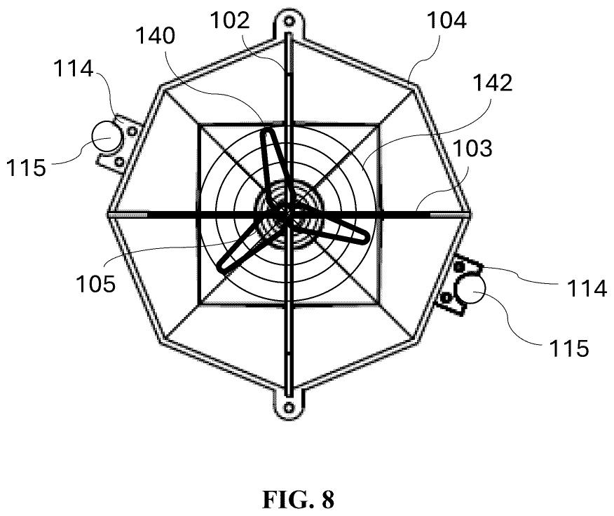

FIG. 8 illustrates a top view of an embodiment of a system for capturing insects of the present patent document. In FIG. 8, the fan 140 is shown located in the housing 104. In FIG. 8, the fan 140 is located below the collection vane 102. In other embodiments, the fan 140 may be located above the collection vane 102. In the embodiment shown in FIG. 8, supports 115 are shown coupled to support holders 114. FIG. 8 also shows a ringed fan guard 142 located above the fan 140. The fan guard 142 may be used to prevent larger objects or animals from contacting the blades of the fan 140.

The components of the insect capturing device 100 may be made of any suitable material, including, but not limited to, plastic or metal. In some embodiments, the components of the insect capturing device 100, such as the collection vane 102, housing 104, funnel 106, vent chamber 108, the support holders 114, the supports 115, and/or the collection chamber 120, among others, may be 3-D printed.

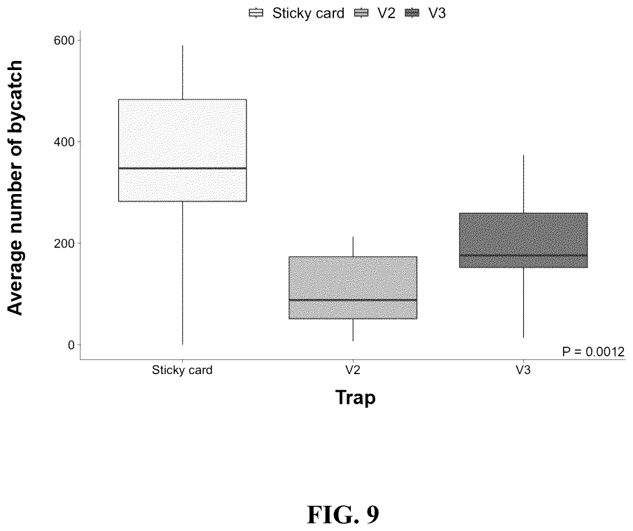

FIG. 9 illustrates a graph of the average number of bycatch caught in different traps in an experiment. In FIG. 9 it is shown that the sticky cards currently in use in the field capture more bycatch than a version 2 and a version 3 of the system for capturing insects of the present patent document.

FIG. 10 illustrates a graph of the average number of thrips caught in different traps in an experiment. In FIG. 10 it is shown that the sticky cards currently in use in the field capture less thrips (the targeted insect of the experiment) than a version 2 and a version 3 of the system for capturing insects of the present patent document.

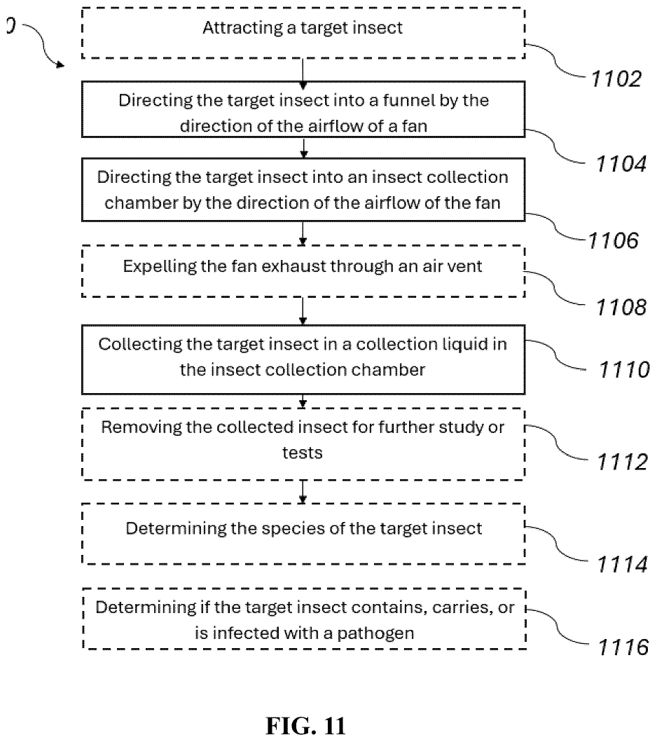

FIG. 11 illustrates a process for capturing insects of the present patent document. Referring to FIG. 11, an embodiment of a method 1100 for capturing insects is shown. In method 1100 for capturing insects, step 1102 comprises attracting a target insect. In some embodiments, the target insect may be attracted using a particular color (e.g., the color blue being used to attract thrips), and/or a particular pheromone. In certain embodiments, some targeted insects may fly into the collection vane and be sucked into the fan by the airflow of the fan, regardless of whether or not they are attracted to a color or a pheromone. Step 1104 comprises directing or moving the target insect into a funnel by the direction of the airflow of a fan. Step 1106 comprises directing or moving the target insect into an insect collection chamber by the direction of the airflow of the fan. Step 1108 comprises expelling the fan exhaust through an air vent. The step of directing or moving the target insect into an insect collection chamber, by the direction of the airflow of the fan, may be done simultaneously while expelling the fan exhaust through an air vent. Step 1110 comprises collecting the target insect in a collection liquid in the insect collection chamber. Step 1112 comprises removing the collected insect for further study or tests. Step 1114 comprises determining the species of the target insect. Step 1116 comprises determining if the target insect contains, carries, or is infected with a pathogen.

The system for capturing insects of the present patent document allows for identifying thrips populations that are actively vectoring economically important viral pathogens and allows for implementing management tactics in a timely manner. Invention: The insect capturing device of the present patent document is a new trap for monitoring and capturing thrips that uses a combination of active and passive methods to capture thrips in a relatively selective manner. In a preferred embodiment, main components of the trap (from top to bottom) may include a 1) wind vane to intercept thrips that are travelling in wind currents, 2) solar-powered fan to draw the thrips downward from the wind vane and into a, 3) funnel, which directs the thrips into a, 4) perforated chamber, which allows air to escape as the thrips are pushed into a, 5) removable collection vial containing, 6) liquid solution to preserve the integrity of the thrips. The wind vane is also colored blue, which is a color that thrips are attracted to. The removable collection vial containing the liquid solution and thrips can be quickly removed and transported to the laboratory, permitting downstream diagnostics on the specimens.

The insect capturing device of the present patent document is an improvement over current technology (e.g., sticky cards), such that insect capturing device 100 is more, 1) effective at capturing thrips, and 2) desirable and productive, such that molecular diagnostics can be easily applied to identify important thrips species and associated plant pathogenic viruses. The insect capturing device 100 is also, 1) less time consuming, and 2) less prone to capturing other insects, including those that are beneficial to the environment (pollinators and parasitoids). In some embodiments, important aspects of the insect capturing device 100 that are involved in capturing the thrips are the blue-colored wind vane and solar-powered fan, while important aspects of the insect capturing device 100 that are involved in storage of the thrips are the collection vial containing liquid solution.

The insect capturing device 100 provides a new surveillance tool that improves the ability to monitor for thrips and thrips-transmitted viruses. The insect capturing device 100 has applications across numerous agricultural commodities where thrips and thrips-transmitted viruses are an issue, including vegetable, fruit, ornamental production in the U.S. and across the world. The insect capturing device 100 may be used in field and greenhouse settings to improve the surveillance of and biosecurity of known and invasive thrips species and viruses. Due to the improved specificity of the trap for capturing thrips, the insect capturing device 100 may be developed into or used as part of an automated monitoring system. The insect capturing device 100 may also be modified (e.g., color of wind vane, addition of insect-specific pheromones) for capturing other important small insect vectors and vector-transmitted pathogens that affect agriculture.

The insect capturing device 100 has the potential to replace traditional use of sticky cards because the insect capturing device 100 has an improved capture rate of thrips and is less time consuming. The insect capturing device 100 also provides additional benefit of collecting the insects in a manner that permits laboratory diagnostics and preservation of the samples. The insect capturing device 100 also has advantages over the current state of art, such that it is more selective towards the target insect and less prone to capturing other insects, including those that are beneficial to the environment, including pollinators and parasitoids. The insect capturing device 100 also creates new opportunities for enhancing the surveillance of insect pests and pathogens, particularly those that are considered exotic or invasive to the U.S. and other countries.

The insect capturing device 100 may be useful for farmers, growers, agriculture producers, and other stakeholders. Through a service, adoptees can receive diagnostic testing of the captured thrips samples, which would provide information of the population of thrips, as well as if viral pathogens are present. The insect capturing device 100 may be useful for researchers and university extensionists who are interested in conducting area-wide surveillance of thrips and thrips-transmitted viruses. The insect capturing device 100 may be used as a decision-support tool, which would lead to improved pest management and quarantine efforts, and resource savings of millions of dollars to the agriculture industry.

In some embodiments, the wavelength for optimal thrips attraction may be 420-470 nanometers (nm). In other embodiments, other colors may be used to selectively target other insect pests and insect vectors of plant pathogens.

Some additional features or modifications to the existing traps may be made to improve capture efficiency. For example, in some embodiments a second fan may be added. In certain embodiments, a fan may be located on top of the wind vane. In some embodiments, there may be a first fan located below the wind vane, and a second fan located above the wind vane. In certain embodiments, there may be more than one fan located below the wind vane. In various embodiments, there may be more than one fan located above the wind vane.

In some embodiments, adjustments to the speed of the fan, such as slower or faster, may be made to optimize the suction of thrips from the wind vane into the collection vial. In certain embodiments, the height and/or width of the wind vane may be modified (e.g., made taller or shorter, or made wider or narrower) to capture more or fewer insects as desired. In some embodiments, the height and/or width of the funnel may be modified (e.g., made taller or shorter, or made wider or narrower) as desired. In various embodiments, the height and/or width of the ventilated chamber may be modified (e.g., made taller or shorter, or made wider or narrower) as desired. A taller and/or wider ventilated chamber may allow more air to escape as thrips are pushed into the collection vial. A taller and/or wider collection vial may hold a greater volume of collection solution.

Some additional features that may be used to improve the capture efficiency may include chemical lures (e.g., aggregation pheromones, sex pheromones, etc.) to selectively attract the target insect (e.g., thrips), lights to selectively attract the target insect (e.g., thrips), size exclusion fixtures to minimize larger non-target insects, or bycatch. Although thrips may be referred to in some embodiments, the system or method may be used with or to target any other insects as well.

Although the embodiments have been described with reference to the drawings and specific examples, it will readily be appreciated by those skilled in the art that many modifications and adaptations of the apparatus and processes described herein are possible without departure from the spirit and scope of the embodiments as claimed hereinafter. Thus, it is to be clearly understood that this description is made only by way of example and not as a limitation on the scope of the embodiments as claimed below.

For the foregoing reasons, the subject matter described herein provides innovative systems and methods for capturing insects. The current system may be modified in multiple ways and applied in various technological applications. The disclosed apparatus, systems, and methods may be modified and customized as required by a specific operation or application, and the individual components may be modified and defined, as required, to achieve the desired result.

Although the materials of construction may not be described, they may include a variety of compositions consistent with the function described herein. Such variations are not to be regarded as a departure from the spirit and scope of this disclosure, and all such modifications as would be obvious to one skilled in the art are intended to be included within the scope of the following claims.

The amounts, percentages and ranges disclosed in this specification are not meant to be limiting, and increments between the recited amounts, percentages and ranges are specifically envisioned as part of the invention. All ranges and parameters disclosed herein are understood to encompass any and all sub-ranges subsumed therein, and every number between the endpoints. For example, a stated range of “1 to 10” should be considered to include any and all sub-ranges between (and inclusive of) the minimum value of 1 and the maximum value of 10 including all integer values and decimal values; that is, all sub-ranges beginning with a minimum value of 1 or more, (e.g., 1 to 6.1), and ending with a maximum value of 10 or less, (e.g. 2.3 to 9.4, 3 to 8, 4 to 7), and finally to each number 1, 2, 3, 4, 5, 6, 7, 8, 9, and 10 contained within the range.

Unless otherwise indicated, all numbers expressing quantities of ingredients, properties such as molecular weight, reaction conditions, and so forth as used in the specification and claims are to be understood as being modified in all instances by the implied term “about.” The (stated or implied) term “about” indicates that a numerically quantifiable measurement is assumed to vary by as much as 30 percent, but preferably by at least 10%. Essentially, as used herein, the term “about” refers to a quantity, level, value, or amount that varies by as much 10% to a reference quantity, level, value, or amount. Accordingly, unless otherwise indicated, the numerical properties set forth in the following specification and claims are approximations that may vary depending on the desired properties sought to be obtained in embodiments of the present invention.

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein.

The foregoing description details certain embodiments of the systems, devices, and methods disclosed herein. It will be appreciated, however, that no matter how detailed the foregoing appears in text, the systems, devices, and methods can be practiced in many ways. It should be noted that the use of particular terminology when describing certain features or aspects of the development should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

The term “consisting essentially of” excludes additional method (or process) steps or composition components that substantially interfere with the intended activity of the method (or process) or composition, and can be readily determined by those skilled in the art (for example, from a consideration of this specification or practice of the invention disclosed herein). The invention illustratively disclosed herein suitably may be practiced in the absence of any element which is not specifically disclosed herein. The term “an effective amount” as applied to a component or a function excludes trace amounts of the component, or the presence of a component or a function in a form or a way that one of ordinary skill would consider not to have a material effect on an associated product or process.

1. An insect capturing device comprising:
a fan;
a housing, wherein the fan is disposed in the housing;
an insect collection chamber, the insect collection chamber coupled to the housing; and
wherein the insect collection chamber comprises a capture liquid disposed in the insect collection chamber, and wherein the insect collection chamber comprises a removable vial configured to be detached from the device to permit quick removal of insects captured therein.

2. The device of claim 1, further comprising:
a collection vane, wherein the collection vane comprises a plurality of panels each connected to a spine.

3. The device of claim 2, wherein the collection vane is coupled to a top of the housing.

4. The device of claim 1, further comprising:
a vent chamber is in gaseous communication with the housing.

5. The device of claim 1, wherein the insect collection chamber is in gaseous communication with the housing.

6. The device of claim 1, further comprising:
a funnel disposed between the fan and the insect collection chamber.

7. The device of claim 6, wherein the housing is coupled to a top end of the funnel.

8. The device of claim 6, wherein the insect collection chamber is coupled to a bottom end of the vent chamber.

9. The device of claim 4, wherein the vent chamber comprises at least one air vent.

10. The device of claim 9, wherein the air vent comprises a mesh.

11. The device of claim 10, wherein the air vent allows a volume of air to pass through the mesh without allowing a targeted insect to pass through the mesh.

12. The device of claim 11, wherein the air vent is disposed in a side wall of the vent chamber.

13. The device of claim 2, wherein the collection vane is disposed above the housing.

14. The device of claim 2, wherein the collection vane is blue.

15. The device of claim 1, wherein the capture liquid comprises water.

16. The device of claim 1, wherein the capture liquid comprises a mixture of water, soap, and propylene glycol.

17. The device of claim 1, further comprising:
a solar panel electrically connected to the fan.

18. An insect capturing device comprising:
a fan;
a housing, wherein the fan is disposed in the housing, the housing having an intake opening and an exhaust opening;
an insect collection chamber, the insect collection chamber coupled to the housing; and
a collection vane coupled to a top of the housing, wherein the collection vane comprises a plurality of panels each connected to a spine.

19. The device of claim 18, wherein the insect collection chamber comprises a capture liquid disposed in the insect collection chamber.

20. The device of claim 18, further comprising:
a vent chamber is in gaseous communication with the housing.

21. The device of claim 20, further comprising:
a funnel disposed between the fan and the insect collection chamber.

22. The device of claim 20, wherein the vent chamber comprises at least one air vent, the air vent comprising a mesh, wherein the air vent allows a volume of air to pass through the mesh without allowing a targeted insect to pass through the mesh.

23. The device of claim 18, wherein the collection vane is a color in the electromagnetic wavelength range of 420-470 nanometers.

24. An insect capturing device comprising:
a fan;
a housing, wherein the fan is disposed in the housing, the housing having an intake opening and an exhaust opening;
an insect collection chamber, the insect collection chamber coupled to the housing; and
a vent chamber is in gaseous communication with the housing, wherein the vent chamber is disposed between the exhaust opening of the housing and the insect collection chamber.

25. The device of claim 24, further comprising:
a collection vane coupled to a top of the housing, wherein the collection vane comprises a plurality of panels each connected to a spine; and
a funnel disposed between the fan and the insect collection chamber.

26. The device of claim 25, wherein the vent chamber comprises at least one air vent, the air vent comprising a mesh, wherein the air vent allows a volume of air to pass through the mesh without allowing a targeted insect to pass through the mesh;
wherein the insect collection chamber comprises a capture liquid disposed in the insect collection chamber; and
wherein the collection vane is blue.

27. A method for capturing insects, the method comprising the steps of:
directing a target insect into a funnel by the direction of the airflow of a fan;
directing the target insect into an insect collection chamber by the direction of the airflow of the fan; and
collecting the target insect in a collection liquid in the insect collection chamber.

28. The method of claim 27, further comprising the step of:
attracting the target insect.

29. The method of claim 28, further comprising the step of:
expelling the fan exhaust through an air vent.

30. The method of claim 29, further comprising the steps of:
removing the collected insect for further study or tests;
determining a species of the target insect; and
determining if the target insect contains, carries, or is infected with a pathogen.
